(19) United States
(12) Patent Application Publication
(10) Pub. No.: US 2025/0058531 A1
(43) Pub. Date: Feb. 20, 2025

(54) AN APPARATUS AND METHOD FOR PREPARING A COMPOSITE AND A COMPOSITE ARTICLE

(71) Applicants: University of Manchester, Manchester (GB); Petroliam Nasional Berhad (Petronas), Kuala Lumpur (MY)

(72) Inventors: Prasad Potluri, Manchester (GB); Mark Bissett, Manchester (GB); Vivek Koncherry, Manchester (GB); Muzdalifah Zakaria, Kuala Lumpur (MY); Zulkifli Ahamid, Kuala Lumpur (MY)

(21) Appl. No.: 18/719,740

(22) PCT Filed: Dec. 13, 2022
(86) PCT No.: PCT/GB2022/053184

§ 371 Date: Jun. 13, 2024

(30) Foreign Application Priority Data
Dec. 13, 2021 (GB) 2117987.4

(51) Int. Cl. B29C 70/32; B29B 15/12; B29B 15/14; B29C 70/02; B29K 307/04; B29K 507/04

(52) U.S. Cl. CPC B29C 70/32; B29B 15/122; B29B 15/14; B29C 70/025; B29K 2307/04; B29K 2507/04

(57) ABSTRACT

The present invention provides an apparatus for preparing a composite, the apparatus comprising: a first container containing a resin; a second container containing a hardener, wherein at least one of the first or second container contains nanoparticles; a metering unit arranged to receive the resin from the first container and the hardener from the second container and configured to output a treating mixture, wherein the metering unit controls a ratio of the resin and the hardener in the treating mixture; and a treatment device arranged to receive a filament and the treating mixture, and treat the filament with the treating mixture to produce the composite.

### TECHNICAL FIELD

The invention concerns an apparatus and method for making composites, particularly by treating a filament. The invention also relates to the composites per se, which have an improved mechanical performance compared to compositions made using conventional techniques, as well as to articles (e.g. pipes) comprising or consisting of the composite.

### BACKGROUND

Composites have been shown to be useful for making lightweight structures such as pipes by filament winding. FIG. 1 illustrates a conventional apparatus 100 for filament winding to make composite pipes. The apparatus 100 consists of a carbon tow package let-off 102 with the untreated carbon tow. The carbon tow passes through a tension control unit 104 and into a resin bath 106 which holds a resin mixture 108 to coat the carbon tow. The resin mixture 108 typically comprises a resin mixed with graphene particles. A robotic control arm unit 110 with robotic arm 110b and winding element 112 operate together with a mandrel 114 having an automated winding motor 116 to wind the coated carbon tow on the mandrel 114. Composite pipes are then fabricated through vacuum bagging.

### SUMMARY

A problem with conventional filament winding is a lack of control of the coating step. For example, a resin bath may comprise various loadings of graphene dispersed in the resin, but the amount of graphene coated onto the filament is difficult to control through a conventional dipping process (as illustrated in FIG. 1). Furthermore, the concentration of the resin mixture 108 can change over time and the resin mixture 108 needs to be stirred regularly to ensure a uniform distribution of the graphene particles in the resin mixture 108. As a result, it is virtually impossible to achieve a constant thickness of resin mixture on the filament or a homogeneous distribution of the nanoparticles on the filament. Ultimately, this impacts on the mechanical performance of the composite, and articles comprising it.

To at least partly solve the above identified problems, according to a first aspect of the present disclosure, there is provided an apparatus for preparing a composite. The apparatus comprises a first container containing a resin (e.g. epoxy resin), and a second container containing a hardener (e.g. epoxy hardener), wherein the first and/or second container contains nanoparticles (typically graphene). The apparatus further comprises a metering unit arranged to receive the resin from the first container and the hardener from the second container. The metering unit is configured to output a treating mixture, wherein the metering unit controls a ratio of the resin and the hardener in the treating mixture. The apparatus further comprises a treatment device arranged to receive a filament (e.g. a carbon tow) and the treating mixture, and to treat the filament with the treating mixture to produce the composite.

The apparatus can hence control and keep the loading of nanoparticles on the filament substantially constant throughout the manufacturing process. The resulting filament therefore has a substantially uniform distribution of both coating and nanoparticles across its surface. The apparatus can also reduce wastage, as the resin and hardener are not mixed until the point of treating so there is no wastage from pre-mixed resin/hardener (for dipping). Approximately 40% of the material costs may be saved compared to a conventional method using a bath for coating. As the nanoparticles are mixed with the resin and/or hardener, prior to any reaction kinetics, instead of to the final mixture, dispersion of the nanoparticles may be improved. This is also believed to contribute to the improved homogeneity of the nanoparticles on the filament surface. The pot life of the nanoparticle-containing mixture is also significantly extended.

The apparatus can hence provide metering, mixing and dispersing of a multicomponent fluid and nanoparticles for in-line dry fibre filament winding, with improved, in particular more uniform, distribution of nanoparticles in the resin and on the filament. The addition of resin, hardener and nanoparticles can optionally be controlled by passing each coated filament through nips or dies. This may be used, for example, to control or regulate the coating thickness. The mechanical properties of the composite can hence be tailored.

The apparatus may further comprise a robotic control arm coupled to the treatment device and a control unit configured to control movement of the robotic control arm. The robotic arm and control unit can control the position of the composite to build a particular composite structure. The composite can be laid in a complex pattern that matches the expected applied load to the composite structure.

The apparatus may further comprise a rotatable mandrel, wherein the robotic control arm is positioned above the rotatable mandrel, and the control unit is configured to move the robotic control arm along a length of the rotatable mandrel during rotation of the rotatable mandrel whilst the composite is dispensed via an output of the treatment device. The mandrel and robotic arm can be operated together to provide an even thickness of composite along the length of the mandrel or to change the local thickness in specific areas if required. For example, by adjusting the speed of the robotic arm and/or the speed of the mandrel, the composite structure (e.g. a composite pipe, pressure vessel or wind turbine blade) can be made thicker at target locations that are expected to experience greater pressures or stress when in use.

The filament can comprise one or more continuous fibres. The term “continuous fibre” is a term of the art and is understood by the skilled person to be a fibre having a very high length to diameter ratio. This ensures that the fibre can be consistently fed into, and processed, through the winding apparatus used for composite manufacture. Typically, the filament comprises a bundle of continuous fibres. For example, the filament may be a carbon fibre tow. A typical single (e.g. carbon) continuous fibre has a diameter of about 7 μm. A bundle of, e.g. carbon, continuous fibres may comprise between 1K and 24K carbon fibres, for example 1K, 3K, 6K, 12K or 24K (1K=1000). A bundle of continuous fibres may have a diameter of 1-10 mm. When using a single continuous fibre as the filament, a fibre having a diameter of about 1 mm may be used.

A further advantage of the apparatus herein described is that when the filament is a plurality of continuous fibres, the nanoparticles are incorporated into the interior of the bundle as well as onto the filament surface. This is believed to occur because the fibres tend to loosen during their passage through the treatment device and the treating mixture, i.e. resin, hardener, and nanoparticles is able to penetrate into the filament between and around individual fibres. Additionally, the nanoparticles are of a sufficiently small size to promote penetration thereof into the interior of the bundle.

The, or each, fibre may comprise, or consist of, a wide range of materials, including polymeric, metallic, ceramic, or carbon-based materials. Preferably the fibre is a polymeric, ceramic or carbon-based material. Representative examples of suitable polymeric materials include polypropylene, polyoxymethylene, polyesters, polyether sulfone, polyether ether, polyether ketone, polyether ether ketone, polyether imide, polyamide, polycarbonate, polyphenols, polyimides, silicones, polyurethanes, and polyepoxides. A preferred polymeric material is polypropylene. Representative examples of suitable ceramic materials include glass and boron. Glass is preferred. A representative example of a carbon-based material is carbon. Particularly preferably the, or each, fibre comprises, or consists of, carbon, glass or polypropylene. Carbon tow is particularly preferred.

The nanoparticles employed in the present invention may be, for example, metals, clays, silicas, carbon nanotubes (CNTs) and graphene. In some embodiments, the nanoparticles are graphene particles. Any form of graphene may be used, i.e. pristine graphene, graphene oxide, reduced oxide graphene and/or graphene nanoplates. The nanoparticles employed in the present invention preferably have an average size of 1-1000 nm, and more preferably 2-500 nm.

In the apparatus of the present invention the resin may be mixed with the nanoparticles. For example, the resin may contain 0.1 to 5% wt of nanoparticles by weight of resin. Alternatively or in addition, the hardener may be mixed with the nanoparticles. For example, the hardener may contain 0.1 to 5% wt of nanoparticles by weight of hardener. The person skilled in the art can modify the amount of nanoparticles present in the resin and/or hardener to an appropriate amount to take into account the amount of nanoparticles desired in the final composite as well as the ratio in which the resin and hardener will be used.

The resin can be selected from any conventional resin used in the preparation of composites. It may be a thermoset or a thermoplastic, but is preferably a thermoset resin. Representative examples of suitable resins include polyester resin, phenolic resin, epoxy resin, vinyl ester resin and polyurethane resin. The hardener obviously needs to be selected to be compatible with the resin. Representative examples of hardeners include peroxides (e.g. for polyester resin and vinyl ester resin), amine based hardener (e.g. for phenolic and epoxy resin) and polyisocyanate (e.g. for polyurethane resin). As an example, the IN2™ epoxy resin and hardener may be used. Suitable resins and hardeners are commercially available. The weight ratio of resin to hardener may be, e.g. 500:1 to 50:30. The person skilled the in art will readily determine suitable ratios.

The treatment device can enable so called in-line wetting of the filament. The apparatus 5 may further comprise a nozzle coupled between the metering unit and the treatment device to supply the treating mixture from the metering unit to the treatment device. The nozzle may comprise an internal structure arranged to mix the resin and the hardener of the treating mixture. For example, the internal structure may comprise internal inwardly facing projections.

The metering unit may comprise an input device for a user to input the ratio. Different applications may require or benefit from different ratios, and the input device can provide an efficient way of changing the ratio as needed.

According to a second aspect of the present disclosure, there is provided a method for preparing a composite (for example a composite according to the second aspect). The method comprises providing a resin in a first container, and providing a hardener in a second container, wherein at least one of the first and second containers contains nanoparticles. The method further comprises supplying the resin from the first container and the hardener from the second container to a metering unit, the metering unit controlling a ratio of the resin and the hardener in a treating mixture output by the metering unit. The method further comprises providing a filament and the treating mixture to a treatment device, and, with the treatment device, treating the filament with the treating mixture to produce the composite.

According to a third aspect of the present disclosure, there is provided a composite that is obtainable by, or obtained by, the method of the second aspect.

According to a fourth aspect of the present disclosure, there is provided a composite comprising, or consisting of, a filament, wherein said filament is coated with a coating comprising resin, hardener and nanoparticles, and said coating is homogeneously distributed on the filament.

An advantage of the apparatus and method herein described is that it provides a much 35 higher level of control over the application of resin, hardener and nanoparticles onto, and into, the filament. As described above, the application of resin, hardener and nanoparticles via the treatment device enables a greater degree of control over the amount of material applied to any given area of filament and ensures that all surfaces of the filament are equally treated. This provides a homogeneous distribution of coating on the filament, i.e. the amount of coating per a given surface area is constant along, and around, the filament. Optionally dies or nips may also be used to regulate the thickness of the coating.

A further advantage of the apparatus and method herein described is that the coating itself is more homogenous or uniform. This arises because of the use of the treatment device to apply the materials and also because the starting material has a more uniform mix of nanoparticles therein. This is due to the fact that the nanoparticles are pre-mixed with either the resin or the hardener, both of which have much lower viscosity than the resin/hardener mixture, thereby allowing for better dispersion of the nanoparticles. Thus in preferred composites of the present invention, said coating is uniform and in particular the distribution of the nanoparticles in said coating is uniform.

The composite of the present invention, particularly when the filament is a plurality of fibres, preferably comprises nanoparticles on the surface of the filament as well as in the interior of the filament. This is particularly advantageous because it significantly improves the mechanical performance of the filament.

### BRIEF DESCRIPTION OF THE DRAWINGS

FIG. 1 shows a schematic diagram of an apparatus for a filament winding process according to a conventional method using a resin bath;

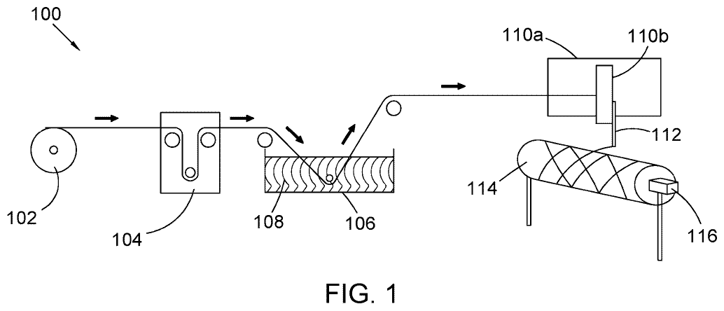

FIG. 2 shows a schematic diagram of an apparatus for filament winding process according to an embodiment;

FIG. 3 shows a schematic diagram of a nozzle through which treating mixture is extruded;

FIG. 4 shows a flow diagram illustrating the steps of a method of making a composite according to an embodiment; and

FIG. 5 shows the results of mechanical testing carried out on a composite preparing using an apparatus and method of the invention.

### DETAILED DESCRIPTION

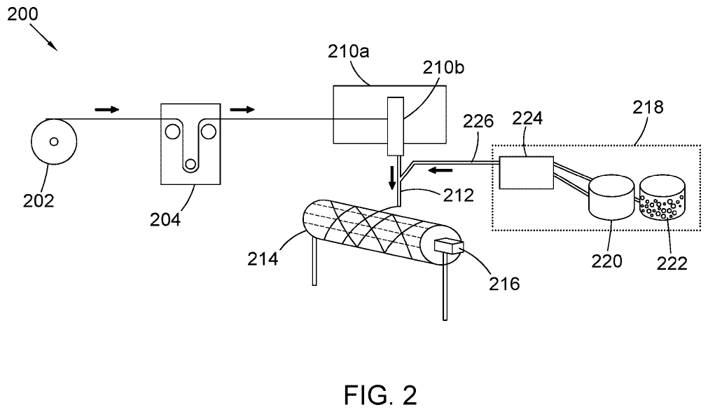

FIG. 2 shows a schematic diagram of an apparatus 200 for a filament winding process to provide a composite. The apparatus comprises a filament let-off 202, like a fibre spool, from which dry filament is provided. The filament may be single continuous fibre filament (a.k.a. monofilament) or a bundle of continuous fibres such as a carbon fibre tow. The dry filament is fed through a tension control unit 204 and to a control unit 210a for controlling a robotic arm 210b. That is, the robotic arm 210b receives an uncoated filament.

FIG. 2 illustrates that the robotic arm 210b is connected to and controls the position of the treatment device 212, through which the composite is provided relative to a mandrel 214 with a motor 216. For example, the mandrel motor 216 may control the mandrel 214 to rotate. The robotic arm control unit 210a and mandrel motor 216 are configured to operate together to provide a particular composite structure (e.g. a composite pipe, pressure vessel or wind turbine blade). Whilst FIG. 2 shows the mandrel having a cylindrical shape (to manufacture a composite pipe) it will be appreciated that this is merely an example, and in embodiments in which a mandrel is used, it can take other forms to that shown in FIG. 2.

In other embodiments, the mandrel 214 and motor 216 may not be present depending on the composite being manufactured. For example, the apparatus 200 may be used to provide a composite in the form of a flat sheet, in this example, the mandrel 214 and motor 216 are not present.

The apparatus 200 further comprises a mixture unit 218 for providing a treating mixture to the treatment device 212. The mixture unit comprises a first container 220 with a resin. The mixture unit also comprises a second container 222 with a hardener. The hardener and/or the resin comprises nanoparticles (e.g. graphene particles).

The resin and hardener is received by a metering unit 224, which outputs a treating mixture through a nozzle 226. The metering unit 224 controls the ratio of the resin and the hardener in the treating mixture i.e. respective quantities of each of the resin and the hardener in the treating mixture. The metering unit may comprise one or more input devices (e.g. a keypad, touchscreen, one or more buttons, rotary switch etc.) to allow a user to specify the ratio of the resin and the hardener in the treating mixture. Alternatively or additionally, the metering unit may comprise a communication interface (e.g. a wired or wireless interface) for receiving a user specified ratio of the resin and the hardener in the treating mixture from a remote computing device. In some embodiments, the ratio of the resin and the hardener in the treating mixture is not specified by a user; in these embodiments, a predetermined ratio of the resin and the hardener in the treating mixture is stored in a memory of the metering unit 224.

The treating mixture is a multicomponent fluid comprising of, or consisting of, resin, hardener and nanoparticles (e.g. graphene particles) and may be further mixed in the nozzle 226. The nozzle may comprise an internal structure that is arranged to mix the components of the treating mixture from the metering unit 224. The nozzle 226 provides the treating mixture to the treatment device 212, which is configured to treat the filament with the treating mixture to provide the composite.

The apparatus 200 treats the filament with the treating mixture to produce the composite by feeding the filament and the treating mixture through the treatment device 212, instead of using a resin bath. This can provide many advantages both to the produced composite (e.g. in terms of both coating and graphene particle distribution) and to the manufacturing process (e.g. reduced wastage and material costs). In the apparatus 200, the resin bath 106 is not present and thus the associated burden of needing to stir a resin mixture in such a resin bath is not incurred.

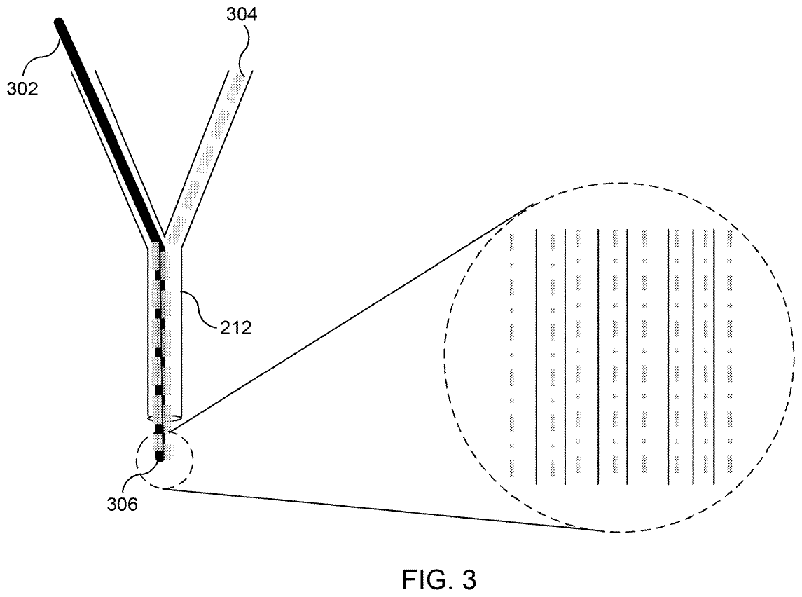

FIG. 3 shows a schematic diagram of the treatment device 212, which may be the treatment device 212 of the apparatus of FIG. 2 (the same reference numerals have been used in different figures to aid understanding and are not intended to limit the illustrated embodiments). The treatment device 212 forms a Y-bend, with dry filament 302 and treating mixture 304 entering through different arms and exiting together at the bottom as a composite 306 (or wetted filament). The treating mixture 304 comprises resin, hardener and nanoparticles (e.g. graphene). A zoomed in section of the composite 306 is shown, where individual fibres (solid lines) can be seen with treating mixture (dash-dot-dash broken lines) interspersed between the fibres. The embodiment can provide a low complexity solution to coating the filament 302 in-line with the winding process. In a simple form, the treatment device provides a conduit in which the filament 302 and treating mixture 304 are brought into contact.

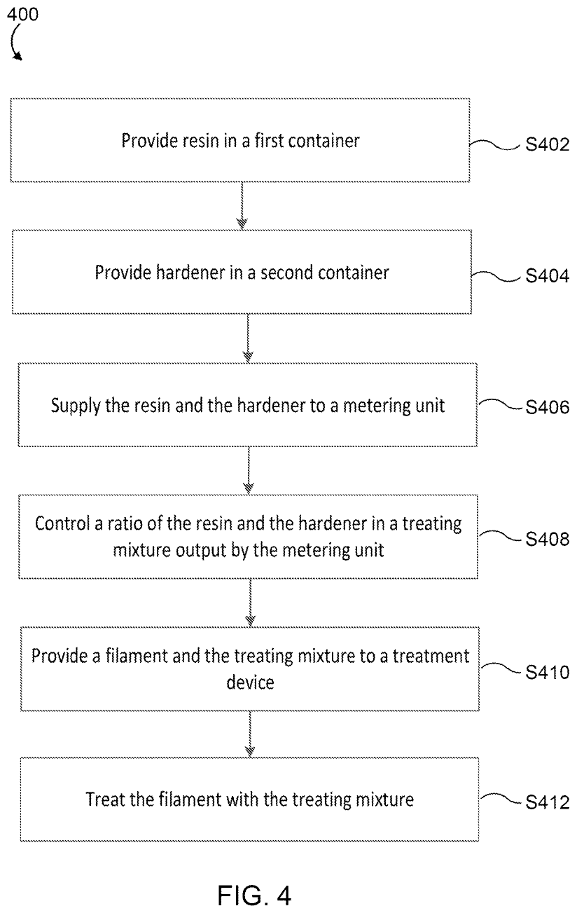

FIG. 4 is a flow diagram illustrating at least some of the steps of a method 400 of making a composite. The method 400 comprises providing a resin in a first container at step S402, providing a hardener in a second container at step S404, and supplying the resin and the hardener to a metering unit at step S406. The method 400 further comprises controlling a ratio of the resin and the hardener in a treating mixture output by the metering unit at step S408. For example, the ratio may be manually input based on a particular desired composite structure. The method 400 then comprises providing a filament and the treating mixture to a treatment device at step S410, and treating the filament with the treating mixture at step S412. The method may comprise further steps of winding the treated filament around a mandrel to form a composite structure (not shown).

While specific embodiments of the method have been described above and in the examples section below, the present disclosure is not limited to those embodiments and the skilled person will appreciate that further embodiments may be provided within the scope of the claims.

### EXAMPLES

### Test Methods

Compression testing in the axial direction was carried out according to ASTM D695 Standard Test Method for Compressive Properties of Rigid Plastics
Compression testing in the radial direction was carried out according to ASTM D2412 Standard Test Method for Determination of External Loading Characteristics of Plastic Pipe by Parallel Plate Loading

For the testing, the specimen size was 15 mm in length. The tests were undertaken at 23° C. and relative humidity of 50%. A biaxial strain gauge (Instron machine) was used.

### Preparation of a Pipe Using the Apparatus and Method of the Present Invention

A pipe with a tube diameter of ±103 mm was prepared using an apparatus as described herein, and according to the method described herein. The mandrel had a diameter of 100 mm, and a robotic arm was employed. The filament was a 24K 50C T700 Toray Carbon Fibre. The resin was a commercially available epoxy resin and the hardener was a commercially available, amine-based hardener. Graphene nanoparticles, with an average diameter of 6.6 μm, were used. These were also available commercially.

A composite pipe was prepared using an apparatus as described herein with an epoxy resin and amine-based hardener. The epoxy resin comprised graphene nanoparticles. The mixture was stirred continuously. The final composite comprised 2 wt % graphene nanoparticles, based on the total weight of the hardener and the resin. A comparative composite pipe was prepared using identical conditions as well as identical hardener and resin, except that the 2 wt % graphene was absent.

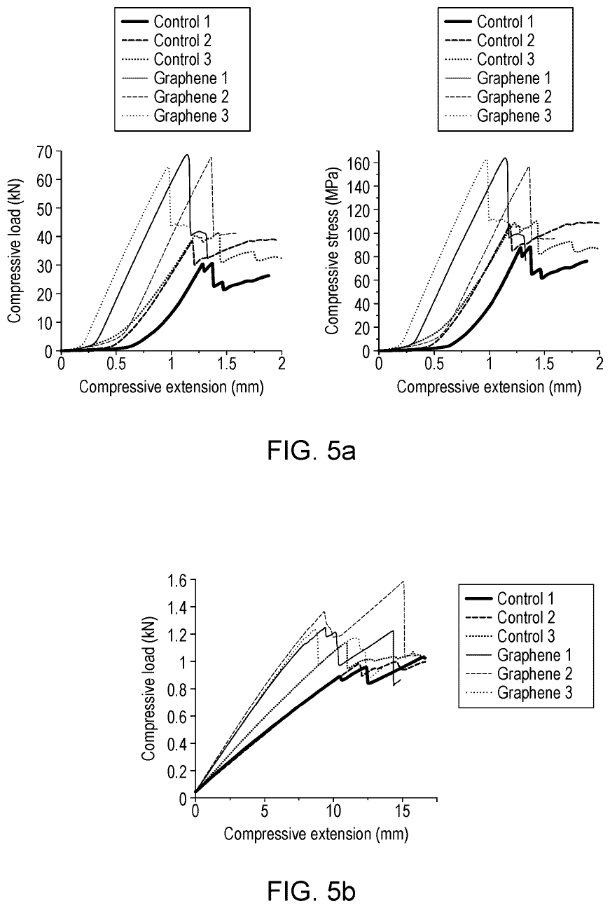

The compressive strength of each pipe was tested in triplicate and the results are shown in FIGS. 5a (axial direction) and 5b (radial direction). FIGS. 5a and 5b show that the composite pipe comprising graphene nanoparticles, and made using the apparatus and method of the invention, has improved mechanical properties in the axial and radial directions compared to the comparative pipe lacking graphene nanoparticles. The Figures show that both the stiffness modulus (as indicated by the slope of the graphs) and the stress at break (as indicated by the peaks of the graphs) is increased in the composite comprising graphene nanoparticles.

It is particularly noteworthy that the improvements achieved are significant. This is believed, at least in part, to be due to the homogeneous distribution of the coating on the filament and the uniform distribution of the graphene nanoparticles in the coating. The fact that the graphene nanoparticles penetrate into the carbon fibre, and not just sit on the surface, is also believed to be a key contributor to the improved mechanical performance of the composite of the present invention.

1. An apparatus for preparing a composite, the apparatus comprising:
a first container containing a resin;
a second container containing a hardener, wherein at least one of the first or second container contains nanoparticles;
a metering unit arranged to receive the resin from the first container and the hardener from the second container and configured to output a treating mixture, wherein the metering unit controls a ratio of the resin and the hardener in the treating mixture; and
a treatment device arranged to receive a filament and the treating mixture, and treat the filament with the treating mixture to produce the composite.

2. The apparatus of claim 1, further comprising:
a robotic control arm coupled to the treatment device; and
a control unit configured to control movement of the robotic control arm.

3. The apparatus of claim 2, further comprising a rotatable mandral, wherein the robotic control arm is positioned above the rotatable mandral, and the control unit is configured to move the robotic control arm along a length of the rotatable mandral during rotation of the rotatable mandral whilst the composite is dispensed via an output of the treatment device.

4. The apparatus of claim 1, wherein the filament is a single continuous fibre.

5. The apparatus of claim 1, wherein the filament comprises a plurality of continuous fibres.

6. The apparatus of claim 5, wherein the filament is a carbon fibre tow.

7. The apparatus of claim 1, wherein the resin comprises the nanoparticles.

8. The apparatus of claim 1, wherein the hardener comprises the nanoparticles.

9. The apparatus of claim 1, wherein the resin is selected from polyester resin, phenolic resin, epoxy resin, vinyl ester resin and polyurethane resin.

10. The apparatus of claim 1, wherein the hardener is selected from epoxy hardener, and an amine based hardener.

11. The apparatus of claim 1, wherein the nanoparticles are graphene nanoparticles.

12. The apparatus of claim 1, further comprising a nozzle coupled between the metering unit and the treatment device to supply the treating mixture from the metering unit to the treatment device.

13. The apparatus of claim 12, wherein the nozzle comprises an internal structure arranged to mix the resin and the hardener of the treating mixture.

14. The apparatus of claim 1, wherein the metering unit comprises an input device for a user to input the ratio.

15. A method for preparing a composite, the method comprising:
providing a resin in a first container;
providing a hardener in a second container, wherein at least one of the first or second container contains nanoparticles;
supplying the resin from the first container and the hardener from the second container to a metering unit,
the metering unit controlling a ratio of the resin and the hardener in a treating mixture output by the metering unit;
providing a filament and the treating mixture to a treatment device; and
the treatment device treating the filament with the treating mixture to produce the composite.

16. A composite which is obtained, or obtainable, by the method of claim 15.

17. A composite comprising a filament, wherein said filament is coated with a coating comprising resin, hardener and nanoparticles, and said coating is homogeneously distributed on the filament.

18. A composite as claimed in claim 17, wherein the distribution of the nanoparticles in said coating is uniform.

19. An article comprising the composite of claim 16.
